(19) United States
(12) Patent Application Publication
(10) Pub. No.: US 2014/0299824 A1
(43) Pub. Date: Oct. 9, 2014

(54) STAPLE-PULLING TOOL AND A METHOD FOR ITS USE

(71) Applicant: Samuel Knox, Philadelphia, PA (US)

(72) Inventor: Samuel Knox, Philadelphia, PA (US)

(21) Appl. No.: 13/856,850

(22) Filed: Apr. 4, 2013

(51) Int. Cl. B25C 11/00

(52) U.S. Cl. CPC B25C 11/00
USPC 254/28

(57) ABSTRACT

The present staple-pulling tool is configured to facilitate the removal of carpet pad staples from floors by a standing user. Specifically, the staple-pulling tool can comprise a handle section, a blade section, and a fulcrum. The handle section can be configured to have an adjustable length capable of fitting users of varying heights. The blade section can be connected to the handle section at an angle. The blade section can comprise a series of teeth that can accommodate the width of carpet pad staples. The fulcrum can be located beneath the handle section and can comprise one or more wheels. The wheels can help a user to move the staple-pulling tool and can also provide leverage for the user to pull the staples. When a user pushes down on the handle, the teeth can pull the carpet pad staples from the floor.

### FIELD OF THE INVENTION

The present device relates to tools that can be used to remove staples from a floor or similar surface after a carpet and/or carpet pad have been removed and a method for using such tools.

### BACKGROUND

Carpets are commonly installed in homes and buildings to create a more comfortable and visually appealing floor surface. Typically, a carpet pad is installed underneath the carpet to add more cushioning to the floor and to help the carpet to remain in place. To install a carpet pad and carpet, a tack strip is usually installed on the floor near the walls of the room in which the carpet is being installed. Next, the carpet pad is attached to the floor with multiple staples prior to installation of the carpet. Finally, the carpet is trimmed to size to fit the particular room and is attached to the tack strips along the walls.

The staples used to attach the carpet pad are typically three-sixteenths ( 3/16ths) to nine-sixteenths ( 9/16ths) in width and made from eighteen (18) gauge or twenty (20) gauge metal. Such staples are configured to be driven through the carpet pad and into the plywood or other wooden flooring to which the carpet pad is being connected. Such staples are usually installed using either manual or pneumatic staple guns that are capable of driving each staple up to three-eighths (⅜ths) of an inch or more into the plywood located below the pad.

Removal or replacement of the carpet pad and carpet necessitates removing the carpet pad from the floor. However, the staples used to secure the carpet pad generally remain in the floor after removal of the old carpet and pad. These staples should be removed prior to utilization of the floor to avoid injury or damage to the new carpet, prior to attachment of a new carpet and pad. Removal of the old staples also avoids the creation of lumps below the new carpet or pad. Generally, these staples are removed using a screwdriver and/or needle nosed pliers. However, these methods of removal require the user to be close to the floor on his or her hands or knees as both screwdrivers and pliers are short, hand-held tools. Removing staples on a user's hands and knees can be very uncomfortable and can lead to injury. Also, the use of hand tools to remove staples can result in breakage of the staples, which then requires further effort to remove all of the remaining pieces. Any broken pieces of staples that are left on the floor can result in the creation of one or more sharp projections, which can be dangerous to people walking on the floor and can lead to foot injuries.

What is needed is a staple-pulling tool configured to be used by a standing person to remove carpet pad staples that are left attached to the floor after the carpet pad has been removed. Specifically, this staple-pulling tool should allow a person to remove staples from a floor while in a standing position with reduced effort while minimizing the breakage of such staples.

### SUMMARY OF THE INVENTION

The present tool can allow a person to remove staples from a floor while in a standing position with reduced effort while minimizing the breakage of such staples.

The above aspect can be obtained by a staple-pulling tool, comprising: a handle section having a first end and a second end and an upper side; a blade section having a first end and a second end and an upper side, wherein the second end of the handle section is connected to the first end of the blade section at a first angle between the upper side of the handle section and the upper side of the blade section; the second end of the blade section comprising one or more teeth; and the handle section comprising a fulcrum located opposite the upper side of the handle section.

The above aspect can also be obtained by a method for using a staple-pulling tool, the method comprising: providing a staple-pulling tool comprising: a handle section having a first end and a second end and an upper side; a blade section having a first end and a second end and an upper side, wherein the second end of the handle section is connected to the first end of the blade section at a first angle between the upper side of the handle section and the upper side of the blade section; the second end of the blade section comprising one or more teeth; and the handle section comprising a fulcrum located opposite the upper side of the handle section: providing a staple connected to a floor; placing one or more teeth between the staple and the floor; and moving the handle section toward the floor until the fulcrum contacts the floor and the one or more teeth move away from the floor lifting the staple out of the floor.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective side view of a staple-pulling tool according to an embodiment;

FIG. 1A is a close-up perspective view of a blade comprising a staple-pulling tool being used to remove staples according to an embodiment;

FIG. 2 is a front view of a staple-pulling tool according to an embodiment;

FIG. 3 is a front view of a staple-pulling tool according to an embodiment;

FIG. 4 is a side view of a staple-pulling tool being held by a user according to an embodiment;

FIG. 5 is a side view of a staple-pulling tool being held by a user according to an embodiment;

FIG. 6A is a front view of a staple inserted into a floor according to an embodiment;

FIG. 6B is a perspective front view of a staple inserted into a floor and securing a carpet pad to the floor according to an embodiment;

FIG. 7A is a perspective top view of teeth from a blade section so that a tooth is positioned underneath a staple according to an embodiment;

FIG. 7B is a top view of a teeth from a blade section so that a tooth is positioned underneath a staple according to an embodiment; and

FIG. 8 is a top view of a blade section comprising trapezoidal teeth wherein a trapezoidal tooth is positioned underneath a staple according to an alternative embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The present carpet pad staple-pulling tool is configured to allow a user to remove carpet pad staples that are attached to a floor from a standing position. Specifically, the present staple-pulling tool can allow a user to hold the staple-pulling tool from a standing position, place the device in a position to remove a staple attached to the floor, and with reduced effort use the tool to remove the staple without breaking or bending it. According to an embodiment, the staple-pulling tool can comprise a handle section and a blade section. The handle section can be connected to the blade section at an angle that allows the user to stand upright while maintaining the blade section in a plane that is roughly parallel to the surface from which the staples are being removed. The fulcrum comprising the tool can be connected to the handle section so as to allow a user to gain proper leverage against the staples allowing the staple-pulling tool to remove staples with reduced effort.

The handle section can comprise an adjustable handle further comprising an outer handle member and an inner handle member. The outer handle member can comprise a hollow opening and the inner handle member can be configured to fit inside the hollow opening of the outer handle member. The inner handle member can be freely adjustable inside the outer handle member. As the staple-pulling tool is configured for use by a standing user, the overall length of the adjustable handle can be adjustable to fit the height of the user. The overall length of the adjustable handle can be longer for a taller user and shorter for a shorter user to allow users of various heights to comfortably use the staple-pulling tool. To shorten the length of the adjustable handle, the inner handle member can be positioned inside the hollow opening of the outer handle member. The inner handle member can be slid into or out of the hollow opening of the outer handle member at varying positions to shorten or lengthen the adjustable handle. Once the user has positioned the inner handle member at an appropriate length for the user's height, the inner handle member can be locked into place.

In an embodiment, the adjustable handle can be connected to a blade section of the staple-pulling tool. The blade section can comprise a first end and a second end and an upper side. The first end of the blade section can be connected to the second end of the handle section and the second end of the blade section can comprise one or more teeth. As mentioned above, the blade section can be connected to the handle section at an angle that allows a user to hold the handle while standing and allow the blade section to be approximately parallel to the floor. In an embodiment, the blade section can be connected to the handle section at an angle of approximately one hundred thirty-five degrees) (135°) resulting in an angle between the handle and the floor of approximately forty-five degrees) (45°). Note that both of these angles are rough approximations and angle variations of plus or minus thirty (30) to fifty (50) degrees can be acceptable embodiments of the present inventive concept. The teeth comprising the second end of the blade section can be triangular in shape and each tooth can comprise a base width wide enough to allow an entire top surface of a carpet pad staple to be supported by each tooth. In this way, the staple can be prevented from breaking while being pulled by the teeth. In an embodiment, each tooth on the outer blade edge can comprise a base width of three-eighths inches (⅜″) or of five-eighths inches (⅝″). In an alternative embodiment, each tooth can have a base width wide enough so that two teeth would support the top surface of a staple.

In an embodiment, the staple-pulling tool can comprise a fulcrum located on the lower side of the handle section. The fulcrum can be located at or near the point of connection between the handle section and the blade section. In another embodiment, the fulcrum can be connected to the bottom portion of the handle or to a bottom of the handle cover. The fulcrum can comprise one or more wheels. These wheels can allow the user to move the staple-pulling tool into the proper position to remove carpet pad staples from the floor. The wheels can also act as a fulcrum to provide more leverage for the user to use the staple-pulling tool to remove carpet pad staples.

In an embodiment, a user can adjust the length of the handle to allow the user to comfortably use the staple-pulling tool while standing up. The user can align the hole at the bottom portion of the handle with a hole on the handle cover and can insert a locking pin through both holes. In another embodiment, the user can slide the inner handle member into the outer handle member and can lock the inner handle member into place in a proper position so that the handle is the appropriate length. The user can move the staple-pulling tool using the wheels into a proper position so that the teeth comprising the blade section are positioned to be placed underneath a carpet pad staple. The user can utilize the leverage provided by the fulcrum, wherein pushing down on the handle consequently pulls the blade section and the teeth up. When the blade section, and specifically the teeth comprising the blade section, are moved upwards, the carpet pad staples can be pulled up by the teeth without breaking the staples. In this manner, the user can remove carpet pad staples from the floor using the staple-pulling tool while in a standing position.

Reference will now be made in detail to the present embodiments of the staple-pulling tool, examples of which are illustrated in the accompanying drawings, wherein like reference numerals refer to like elements throughout.

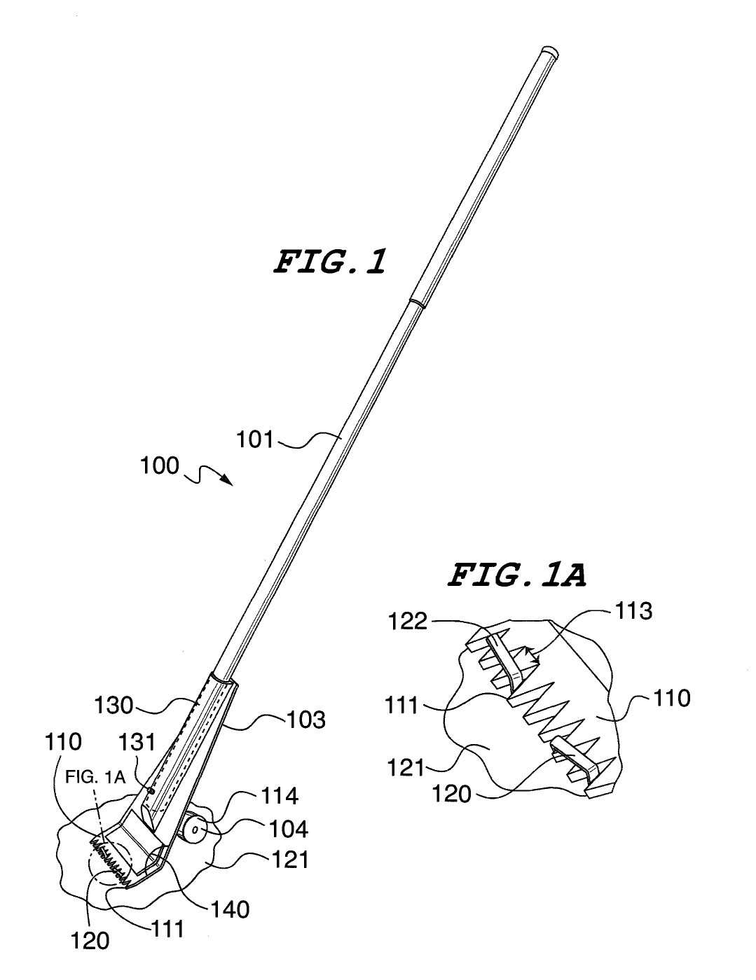

FIG. 1 is a perspective front and side view of a staple-pulling tool 100 according to an embodiment. The staple-pulling tool 100 can comprise a blade section 110 and a handle section 103 connected at a first angle 140. The blade section 110 can comprise one or more teeth 111, which can be configured to be placed below the top of a carpet staple 120, which is known as the “crown” of the staple, connected to a floor 121. In an embodiment, a fulcrum 104 can be connected to the handle section 103 and this fulcrum can comprise one or more wheels 114. In an alternative embodiment, the fulcrum could comprise runners or any other device configured to help the tool 100 move across a surface. In an embodiment an adjustable handle 101 can connect to the handle section 103 of the staple-pulling tool 100. In the embodiment shown in FIG. 1, the handle section 103 comprises a handle receiving compartment 130 wherein one end of the adjustable handle 101 is connected to the handle receiving compartment 130 using one or more fasteners 131. These fasteners 131 can be screws, bolts, rivets, pins, or any other suitable fasteners. In an alternative embodiment, the handle 101 could also be connected to the handle section 103 using a connection means that does not require a fastener, such as for example, a screwed-in connection or gluing. Additionally, a handle receiving compartment is not required to create a fully functional staple-pulling tool 100.

FIG. 1A is a close-up perspective view of a blade 110 comprising a staple-pulling tool 100 in a position to remove staples 120 from a floor 121 according to an embodiment. In an embodiment, the teeth 111 of the blade 110 can be positioned underneath the crown portion 122 of each staple 120. As discussed above, it is an important feature of the present tool 100 to provide maximum support to the crown portion 122 of each staple being pulled as breakage can occur if the crown is not fully supported. It is very important to avoid such breakage due to the fact that a broken staple (not shown in FIG. 1A) could pose a sharp safety hazard and would be very difficult if not impossible for a person to remove while standing. Maximum support for the crown portion 122 can be provided when the base width 113 of each tooth 111, or sets of two or more teeth 111, is configured to equal, or nearly equal, the width of the crown portion 122 of the carpet staple 120. In FIG. 1A the base width 113 of each tooth is configured so that two teeth can fully support the crown portion 122.

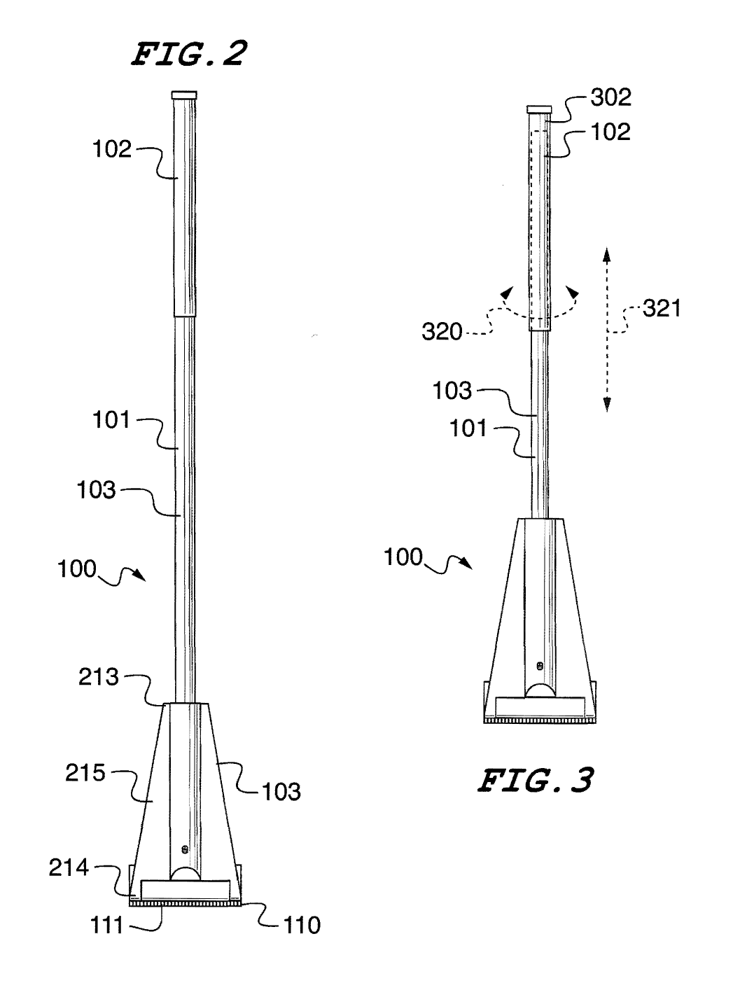

FIG. 2 is a front view of a staple-pulling tool 100, wherein the adjustable handle 101 is shown in a fully extended position according to an embodiment. In this figure, the outer handle member 102 is connected to the inner handle member 103 at a point furthest from the handle section 103. This view also shows the position of the blades section 110 and its teeth 111 as those positions relate to the handle section 103. As can also be seen in FIG. 2, the handle section 103 can comprise a first end 213, a second end 214 and an upper side 215.

FIG. 3 is a front view of a staple-pulling tool 100, wherein the adjustable handle 101 is shown in a fully contracted position according to an embodiment. In this figure, the outer handle member 102 is connected to the inner handle member 103 at a point closest to the handle section 103. In this view, the hollow compartment 302 of the outer handle member 102 can contain part of the inner handle member 103, according to an embodiment. Linear adjustment of the length of the adjustable handle 101 can be achieved by moving the outer handle member 102 up or down, as shown by arrows 321, and the handles can be locked into a selected position by rotating the outer handle member 102 with respect to the inner handle member 103 as shown by arrows 320, according to an embodiment.

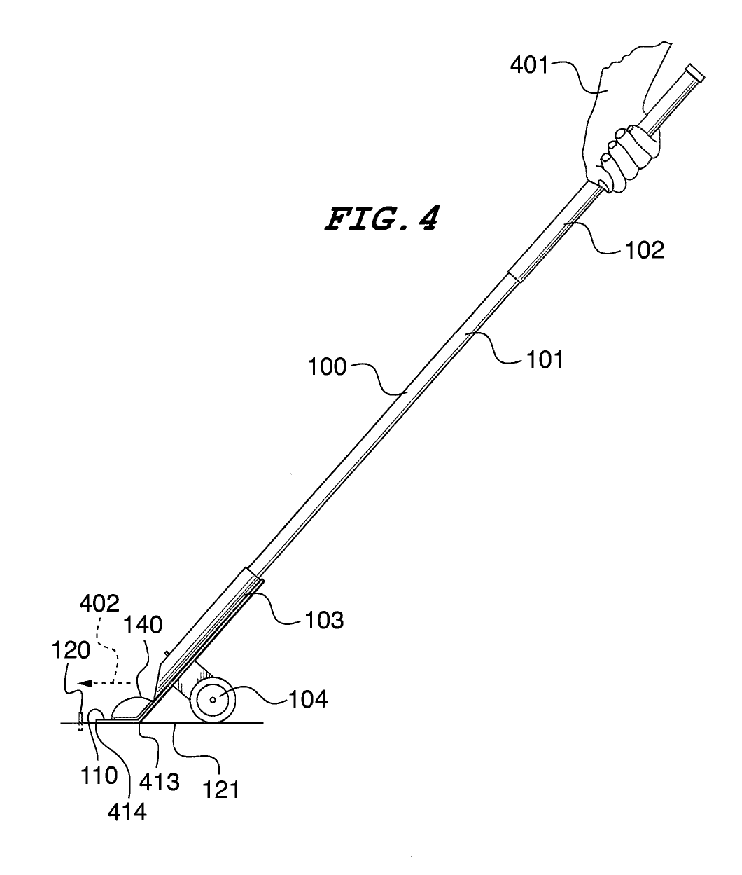

FIG. 4 is a side view of a staple-pulling tool 100 being held by a user 401 according to an embodiment. One of the primary features of the present tool 100 is its ability to be used by a person in a standing position. FIG. 4 shows the angle between both the handle section 103 and the adjustable handle 101 and the floor 121. In an embodiment, this angle can be approximately forty-five (45) degrees. However, this angle can be adjusted by the user 401 by adjusting the length of the adjustable handle 101 by moving the outer handle member 102 either closer to or further away from the handle section 103.

FIG. 4 also shows the relative position of the blade section 110 as it relates to the floor 121 and a staple 120 connected to that floor. In an embodiment, the blade section 111 can be parallel to the floor 121 as the staple-pulling tool 100 is moved toward the staple 120 in a forward direction 402. As can also be seen in FIG. 4, the blade section 110 can comprise a first end 413 and a second end 414.

FIG. 5 is a side view of a staple-pulling tool 100 being held by a user 401, which is being pressed down to remove a staple 120, according to an embodiment. After the blade section 110 of the staple-pulling tool 100 is placed into contact with one or more staples 120, as shown in FIG. 1A, the adjustable handle 101 can be pushed in a downward direction 502 by the user 401. This downward motion can cause the handle section 103 to rotate about the fulcrum 103, as shown by directional arrow 503, causing the blade section 110 to move upward thus pulling the staple 120 from the floor 121 or similar surface.

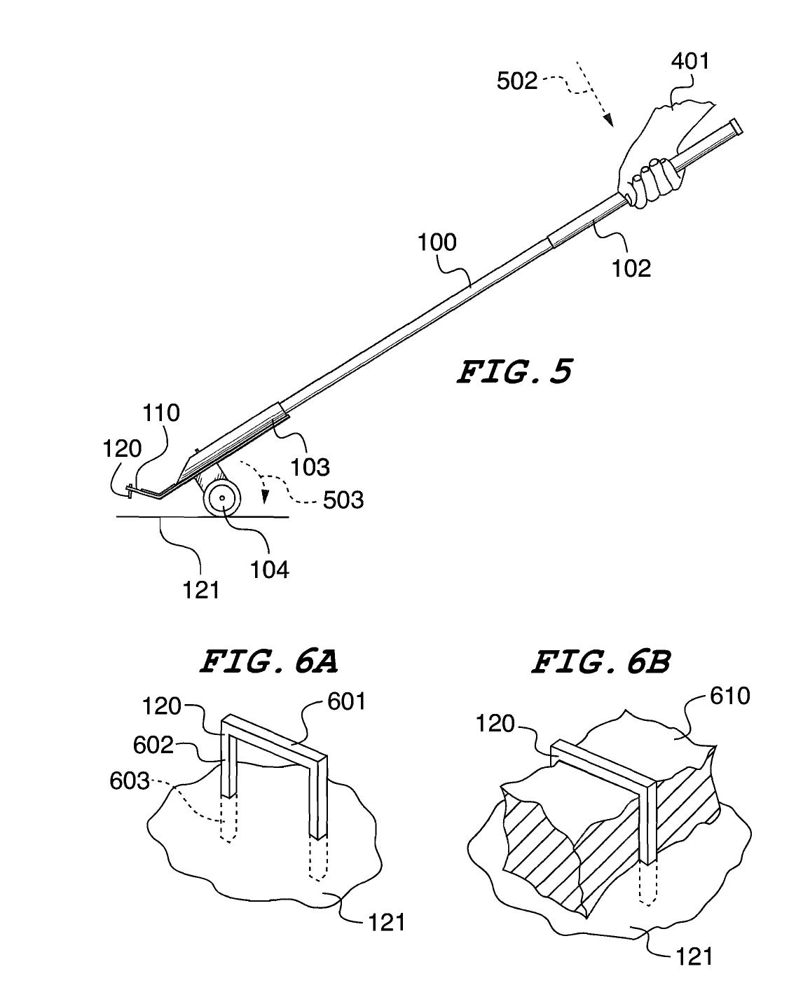

FIG. 6A is a front view of a staple 120 inserted into a floor 121. The staple 120 can comprise a crown portion 601, leg portions 602, and staple teeth 603. The staple teeth 603 of the staple 120 are typically inserted into the floor 121 in a manner so that the leg portions 602 are are roughly perpendicular to the floor 121 and the crown 601 is roughly parallel to the floor 121.

FIG. 6B is a perspective front view of a staple 120 inserted into a floor 121 and securing a piece of carpet pad 610 to the floor 121 according to an embodiment. It is typical for a staple 120 to retain a piece of carpet pad 610 when the carpet pad is removed from the floor. In an embodiment, the teeth 111 comprising the present staple-pulling tool 100 can push this piece of carpet pad 610 out of the way when removing a staple 120 from the floor 121.

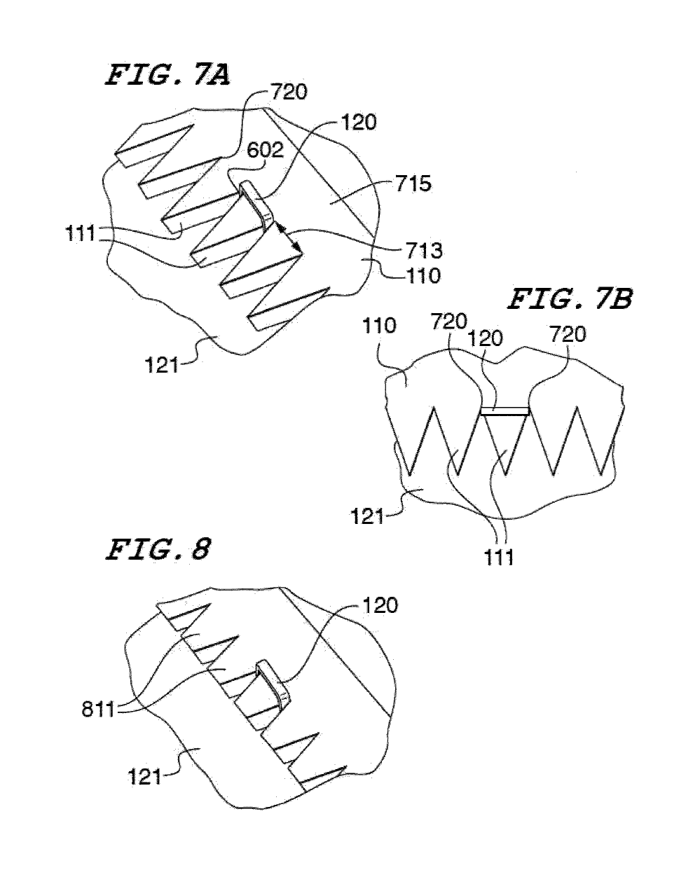

FIG. 7A is a perspective top view, showing the upper side 715 of the blade section, wherein the teeth 111 comprising a blade section 110, are positioned so that a single tooth 111 is located underneath a staple 120 according to an embodiment. In an embodiment, the base width 713 of each tooth 111 can equal, or nearly equal the length of the crown 601 of a staple 120 and the leg portions of the staple 602 can be gripped by the point 720 where two teeth 111 meet. This gripping of the leg portions of the staple 602 can facilitate the lifting and removal of each staple 120 from a floor 121 and can further reduce the likelihood that the staple 120 may break during the removal process.

FIG. 7B is a top view of teeth 111 from a blade section 110 wherein a tooth 111 is positioned underneath a staple 120, and the leg portions of the staple (not visible in FIG. 7B) are gripped at one or more points 720 where two teeth 111 meet, according to an embodiment.

FIG. 8 is a top view of a blade section 110 comprising trapezoidal teeth 811 wherein a trapezoidal tooth 811 is positioned underneath a staple 120 connected to a floor 121 according to an alternative embodiment. In an embodiment, each of the teeth 811 comprising the blade section 110 can comprise a non-stick coating allowing each tooth 811 to more easily slide below a staple 120.

Although the present tool has been described in terms of exemplary embodiments, it is not limited thereto. Rather, the appended claims should be construed broadly, to include other variants and embodiments of the present tool, which may be made by those skilled in the art without departing from the scope and range of equivalents of the present tool.

What is claimed is:

1. A staple-pulling tool, comprising:
a handle section having a first end and a second end and an upper side;
a blade section having a first end and a second end and an upper side, wherein the second end of the handle section is connected to the first end of the blade section at a first angle between the upper side of the handle section and the upper side of the blade section;
the second end of the blade section comprising one or more teeth; and
the handle section comprising a fulcrum located opposite the upper side of the handle section.

2. A staple-pulling tool as described in claim 1, wherein the first angle is between 115 and 155 degrees.

3. A staple-pulling tool as described in claim 1, wherein one or more teeth are triangular in shape.

4. A staple-pulling tool as described in claim 1, wherein one or more teeth are trapezoidal in shape.

5. The staple-pulling tool as described in claim 1 wherein each tooth comprises a non-stick coating.

6. A staple-pulling tool as described in claim 1, wherein the second end of the handle section comprises an adjustable handle.

7. A staple-pulling tool as described in claim 6, wherein the adjustable handle comprises an inner handle member and an outer handle member.

8. A staple-pulling tool as described in claim 6, wherein the handle section comprises handle receiving compartment configured to accept the adjustable handle.

9. A staple-pulling tool, comprising:
a handle section having a first end and a second end and an upper side;
a blade section having a first end and a second end and an upper side, wherein the second end of the handle section is connected to the first end of the blade section at a first angle between the upper side of the handle section and the upper side of the blade section;
the second end of the blade section comprising one or more teeth; and
the handle section comprising a fulcrum, located opposite the upper side of the handle section, comprising one or more wheels.

10. A staple-pulling tool as described in claim 9, wherein the first angle is between 115 and 155 degrees.

11. A staple-pulling tool as described in claim 9, wherein one or more teeth are triangular in shape.

12. A staple-pulling tool as described in claim 9, wherein one or more teeth are trapezoidal in shape.

13. The staple-pulling tool as described in claim 9 wherein each tooth comprises a non-stick coating.

14. A staple-pulling tool as described in claim 9, wherein the second end of the handle section comprises an adjustable handle.

15. A staple-pulling tool as described in claim 14, wherein the adjustable handle comprises an inner handle member and an outer handle member.

16. A staple-pulling tool as described in claim 14, wherein the handle section comprises handle receiving compartment configured to accept the adjustable handle.

17. A method for using a staple-pulling tool, the method comprising:
providing a staple-pulling tool comprising: a handle section having a first end and a second end and an upper side; a blade section having a first end and a second end and an upper side and, wherein the second end of the handle section is connected to the first end of the blade section at a first angle between the upper side of the handle section and the upper side of the blade section; the second end of the blade section comprising one or more teeth; and the handle section comprising a fulcrum, located opposite the upper side of the handle section, which comprises one or more wheels:
providing a staple connected to a floor;
placing one or more teeth between the staple and the floor; and
moving the handle section toward the floor causing the blade section to rotate about the fulcrum and one or more teeth to move away from the floor lifting the staple out of the floor.

18. A method for using a staple-pulling tool as described in claim 17, wherein the second end of the handle section comprises an adjustable handle and the handle section is moved toward the floor by moving the adjustable handle toward the floor.

19. A method for using a staple-pulling tool as described in claim 18, wherein the adjustable handle comprises an inner handle member and an outer handle member.

20. A method for using a staple-pulling tool as described in claim 18, wherein the handle section comprises handle receiving compartment configured to accept the adjustable handle.
